(19) United States
(12) Patent Application Publication
(10) Pub. No.: US 2018/0302788 A1
(43) Pub. Date: Oct. 18, 2018

(54) BACKUP VEHICLE ENTRY AND USER AUTHENTICATION SYSTEM

(71) Applicant: GM GLOBAL TECHNOLOGY OPERATIONS LLC, Detroit, MI (US)

(72) Inventors: JEFFREY L. KONCHAN, ROMEO, MI (US); KENNETH G. DANAJ, STERLING HEIGHTS, MI (US)

(73) Assignee: GM GLOBAL TECHNOLOGY OPERATIONS LLC, Detroit, MI (US)

(21) Appl. No.: 15/487,273

(22) Filed: Apr. 13, 2017

(51) Int. Cl. H04W 12/06; E05B 19/00; E05B 19/04; B60R 25/24; B60R 25/04; H04M 1/02; H04B 1/3888

(52) U.S. Cl. CPC H04W 12/06; E05B 19/0082; E05B 19/0058; H04B 1/3888; B60R 25/241; B60R 25/04; H04M 1/0202; E05B 19/04

(57) ABSTRACT

Systems are provided for a backup entry and user authentication system for a vehicle. In one example, the system includes a smart phone having a housing that defines at least one recess. The system also includes an entry key having a blade adapted to mate with a lock of the vehicle to gain entry into the vehicle. The entry key is removably retained within the at least one recess. The system includes a transponder associated with the smart phone that outputs one or more signals that identifies a user to a processor of the vehicle, and the processor of the vehicle enables a startup of a propulsion system of the vehicle based on the identification.

### TECHNICAL FIELD

The present disclosure generally relates to vehicles, and more particularly relates to a backup entry key and user authentication system for a vehicle, which permits access to the vehicle and enables starting of the vehicle.

### BACKGROUND

Certain vehicles, such as motor vehicles, may employ a keyless entry system and/or a remote start system to provide convenience to the user of the motor vehicle. Generally, the keyless entry system includes a key fob, which transmits one or more signals to the vehicle to enable locking, unlocking and starting of an engine of the vehicle upon receipt of the respective signal. In certain instances, however, the keyless entry system may be unavailable due to loss of the key fob, issues with a battery of the key fob, and so on. In these instances, the user may be unable to enter the vehicle and may be unable to start the vehicle.

Accordingly, it is desirable to provide a vehicle backup entry key and a backup user authentication system so that the user may enter the vehicle and may be able to start the vehicle in instances where the key fob is unavailable or other issues exist with the key fob. It is also desirable to provide this system in a device that is portable and may be carried by the user, to reduce the occurrence of the user's misplacement of the system. Furthermore, other desirable features and characteristics of the present disclosure will become apparent from the subsequent detailed description and the appended claims, taken in conjunction with the accompanying drawings and the foregoing technical field and background.

### SUMMARY

According to various embodiments, provided is a backup entry and user authentication system for a vehicle. The system includes a smart phone having a housing that defines at least one recess. The system also includes an entry key having a blade adapted to mate with a lock of the vehicle to gain entry into the vehicle. The entry key is removably retained within the at least one recess. The system includes a transponder associated with the smart phone that outputs one or more signals that identifies a user to a processor of the vehicle, and the processor of the vehicle enables a startup of a propulsion system of the vehicle based on the identification.

The at least one recess comprises a first recess and a second recess. The entry key is received within the first recess and a key release actuator is received at least partially within the second recess. The key release actuator includes a button coupled to a latch, and a movement of the button relative to the second recess moves the latch relative to the first recess to release the entry key. The at least one recess is defined through a portion of a sidewall of the housing and the entry key includes a sidewall portion that corresponds with the sidewall of the housing such that a graspable portion of the entry key is substantially flush with the sidewall of the housing when the entry key is retained within the at least one recess. The transponder is coupled to the housing of the smart phone. The transponder is coupled to the entry key.

Also provided is a backup entry and user authentication system for a vehicle. The system includes a housing having a base that defines a recess. The housing is adapted to receive a portable user device. The system includes an entry key having a blade adapted to mate with a lock of the vehicle to gain entry into the vehicle. The entry key is removably retained within the recess. The system also includes a transponder associated with the housing that outputs one or more signals that identifies a user to a processor of the vehicle and the processor of the vehicle enables a startup of a propulsion system of the vehicle based on the identification.

The recess includes a notch to remove the entry key from the housing. The recess is defined such that the entry key is substantially flush with a surface of the base when retained within the recess. The transponder is coupled to the base of the housing. The transponder is coupled to the entry key.

In various embodiments, a backup entry and user authentication system for a vehicle is provided. The system includes a smart phone having a housing that defines a first recess through a portion of a sidewall of the housing. The system includes an entry key having a blade adapted to mate with a lock of the vehicle to gain entry into the vehicle and a graspable portion. The entry key is removably retained within the first recess. The graspable portion includes a sidewall portion that corresponds with the sidewall of the housing such that the graspable portion of the entry key is substantially flush with the sidewall of the housing when the entry key is retained within the first recess. The system includes a transponder coupled to the housing that outputs one or more signals that identifies a user to a processor of the vehicle and the processor of the vehicle enables a startup of a propulsion system of the vehicle based on the identification.

The system includes a key release actuator that is received at least partially within a second recess defined in the housing. The key release actuator includes a button coupled to a latch, and a movement of the button relative to the second recess moves the latch relative to the first recess to release the entry key.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle having a backup entry and user authentication system, in accordance with various embodiments;

FIG. 2 is a perspective view of a portable device that contains the backup entry and user authentication system in accordance with various embodiments; and

FIG. 3 is a perspective view of another portable device that contains the backup entry and user authentication system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of schematic, functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the vehicle systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

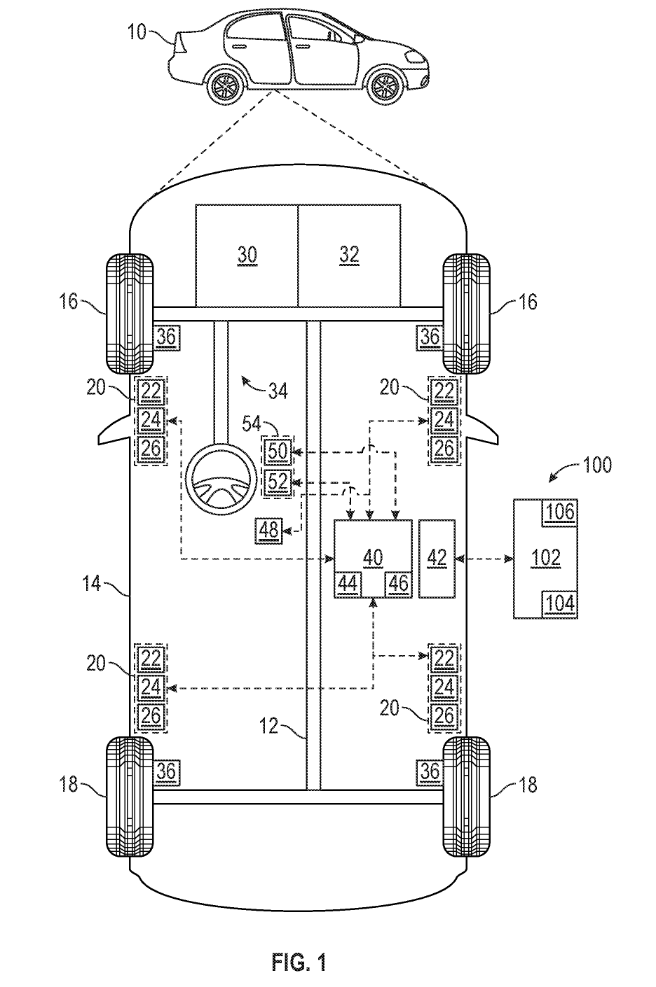

With reference to FIG. 1, a backup entry and user authentication system shown generally at 100 is associated with a vehicle 10 in accordance with various embodiments. In general, the backup entry and user authentication system 100 provides a portable device 102, which includes an entry key 104, 104′ and at least one authentication system 106, 106′, 106″. The backup entry and user authentication system 100 enables a user to enter the vehicle 10 and identify themselves to the vehicle 10 to enable a startup of the vehicle 10, as will be discussed further herein. Although the figures shown herein depict an example with certain arrangements of elements, additional intervening elements, devices, features, or components may be present in an actual embodiment. It should also be understood that FIG. 1 is merely illustrative and may not be drawn to scale.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the vehicle 10 includes one or more doors 20. Each of the doors 20 is pivotally coupled to the vehicle 10 to be movable between an opened position and a closed position. Each of the doors 20 also includes a lock 22. In one embodiment, the lock 22 includes a lock cylinder 24, which receives the entry key 104, 104′. The rotation of the entry key 104, 104′ within the lock cylinder 24 moves a lock bolt 26 between an extended position and a retracted position. Generally, in the extended position, the lock bolt 26 is engaged with a portion of the body 14 to prevent the opening of the respective door 20, and in the retracted position, the respective door 20 is able to be moved relative to the body 14 to the opened position. Thus, the entry key 104, 104′ enables entry into the cabin of the vehicle 10. In addition, one or more of the locks 22 may be responsive to one or more control signals from at least one controller 40 of the vehicle 10 to move the lock between a locked and unlocked position. Thus, the locks 22 may be part of a keyless entry system (active or passive), which may allow a user to enter the vehicle 10 by one or more signals transmitted via a key fob (not shown) associated with the vehicle 10. The vehicle 10 is depicted in the illustrated embodiment as a passenger car, but it should be appreciated that any other vehicle including trucks, sport utility vehicles (SUVs), recreational vehicles (RVs), marine vessels, aircraft, etc., can also be used.

As shown, the vehicle 10 generally includes a propulsion system 30, a transmission system 32, a steering system 34, a brake system 36, the controller 40, and a communication system 42. The propulsion system 30 may, in various embodiments, include an internal combustion engine, an electric machine such as a traction motor, and/or a fuel cell propulsion system. The propulsion system 30 is in communication with the controller 40 to receive one or more control signals to start the propulsion system 30. Generally, the propulsion system 30 is in communication with the controller 40 over a communication medium that enables the transfer of data, commands, etc. The transmission system 32 is configured to transmit power from the propulsion system 30 to the wheels 16-18 according to selectable speed ratios. According to various embodiments, the transmission system 32 may include a step-ratio automatic transmission, a continuously-variable transmission, or other appropriate transmission. The brake system 36 is configured to provide braking torque to the wheels 16-18 and/or the transmission system 32. The brake system 36 may, in various embodiments, include friction brakes, brake by wire, a regenerative braking system such as an electric machine, and/or other appropriate braking systems. The steering system 34 influences the course of travel by the vehicle 10, for example by adjusting a position of the wheels 16-18.

The controller 40 includes at least one processor 44 and a computer readable storage device or media 46. The processor 44 can be any custom made or commercially available processor, a central processing unit (CPU), a graphics processing unit (GPU), an auxiliary processor among several processors associated with the controller 40, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 40 in controlling the starting of the propulsion system 30 of the vehicle 10.

The instructions may include one or more separate programs, each of which comprises an ordered listing of executable instructions for implementing logical functions. The instructions, when executed by the processor 44, receive and process signals from the backup entry and user authentication system 100, perform logic, calculations, methods and/or algorithms for controlling the components of the vehicle 10, and generate control signals to the propulsion system 30 to start the propulsion system 30 based on the logic, calculations, methods, and/or algorithms. Although only one controller 40 is shown in FIG. 1, embodiments of the vehicle 10 can include any number of controllers 40 that communicate over any suitable communication medium or a combination of communication mediums and that cooperate to process the sensor signals, perform logic, calculations, methods, and/or algorithms, and generate control signals to control features of the vehicle 10.

In various embodiments, one or more instructions of the controller 40 are associated with the backup entry and user authentication system 100 and, when executed by the processor 44, the instructions receive and process signals from the authentication system 106, 106′, 106″ to determine various conditions associated with the operation of the vehicle 10. For example, as will be discussed herein, the instructions of the controller 40, when executed by the processor 44, determine whether an input is received to start the propulsion system 30. In various embodiments, the input is received from a starter input device 48. In various embodiments, the starter input device 48 is a button, switch, lever or other input device that receives an input from a user to start the propulsion system 30. In one example, the starter input device 48 is coupled to an interior of the vehicle 10 so as to be accessible by a driver or user of the vehicle 10. The starter input device 48 is in communication with the processor 44 over a communication medium that enables the transfer of data, commands, etc.

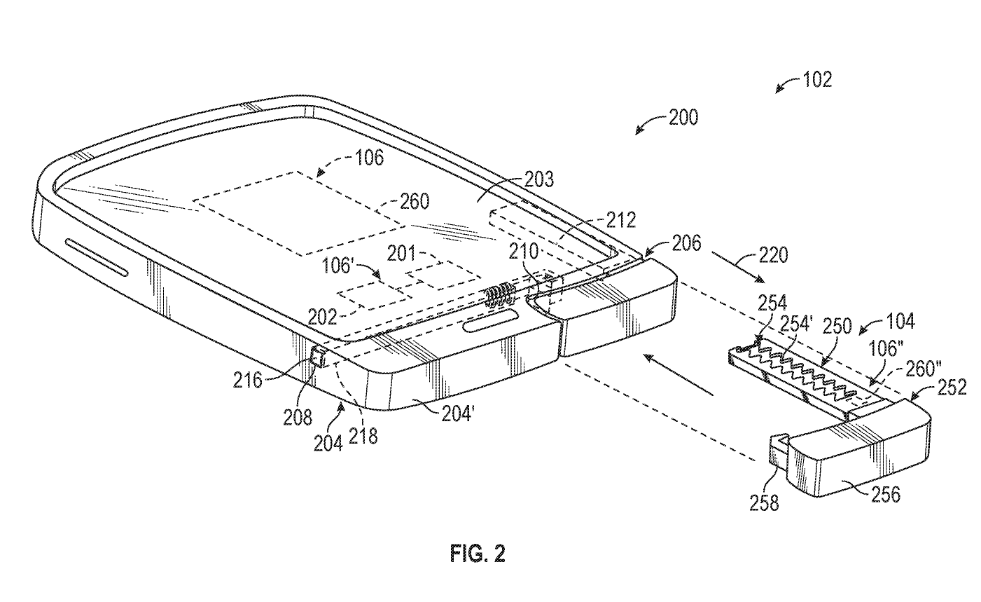

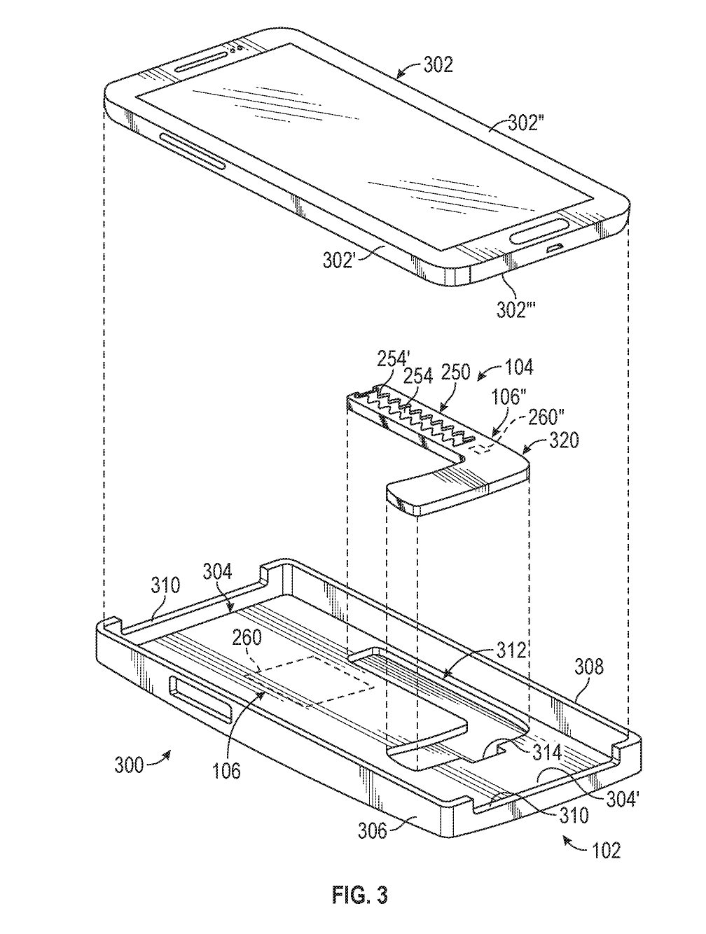

In this example, upon actuation of the starter input device 48, a signal is transmitted to the processor 44. Upon receipt of the signal from the starter input device 48, the processor 44 outputs one or more control signals to a transponder coil 50, such as a low frequency (LF) antenna. Based on the receipt of the one or more control signals, the transponder coil 50 outputs a low frequency signal, which activates a transponder 260, 260″ (FIGS. 2 and 3) associated with the authentication system 106, 106″ of the portable device 102. Upon activation, the transponder 260, 260″ transmits one or more identification signals to a receiver 52 within the vehicle 10 via radio frequency. The receiver 52 communicates the received one or more identification signals from the transponder 260′, 260″ to the processor 44. Each of the transponder coil 50 and the receiver 52 are in communication with the processor 44 over a communication medium that enables the transfer of data, commands, etc. The processor 44 receives and processes the one or more identification signals received by the receiver 52 and determines whether the portable device 102 is associated with the vehicle 10. Based on the determination, the processor 44 enables a starting or start-up of the propulsion system 30. In one example, the transponder coil 50 is coupled to or disposed within a console associated with the vehicle 10, such as a center console 54, and the receiver 52 may also be disposed within the center console 54 or an instrument panel associated with the vehicle 10. It should be noted, however, that the transponder coil 50 and the receiver 52 may be coupled to any desired area within the vehicle 10.

The communication system 42 is configured to wirelessly communicate information to and from the portable device 102. In an exemplary embodiment, the communication system 42 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards. The communication system 42 is in communication with the controller 40 over a communication medium that enables the transfer of data, commands, etc.

Referring now to FIG. 2, the backup entry and user authentication system 100 is shown in greater detail. As discussed with regard to FIG. 1, the backup entry and user authentication system 100 includes the portable device 102, which includes the entry key 104 and at least one of the authentication systems 106, 106′, 106″. In one embodiment, the portable device 102 is a user device 200, including, but not limited to, a smart phone. It will be understood, however, that the user device 200 may comprise any portable user device, including, but not limited to: a mobile computer (e.g., a tablet computer, a laptop computer, or a netbook computer); a video game device; a digital media player; a piece of home entertainment equipment; a digital camera or video camera; a wearable computing device (e.g., smart watch, smart glasses, smart clothing); or the like. The user device 200 is realized as a computer-implemented or computer-based device having the hardware, software, firmware, and/or processing logic needed to carry out the various techniques and methodologies described herein. For example, the user device 200 includes a microprocessor 201 in the form of a programmable device that includes one or more instructions stored in an internal memory structure and applied to receive binary input to create binary output. The user device 200 includes a communication system 202 configured to communicate via a wireless local area network (WLAN) using IEEE 802.11 standards or by using cellular data communication functionality so that the user device 200 carries out voice and/or data communications using one or more cellular communications protocols. In various embodiments, the user device 200 includes a visual display 203, such as a touch-screen graphical display, or other display.

In the example of the portable device 102 as the user device 200, the entry key 104 and the authentication system 106 are contained within a housing 204 of the user device 200. In one example, the housing 204 defines a first recess 206 and a second recess 208. The first recess 206 may be spaced apart from the second recess 208 along a sidewall 204′ of the housing 204. The housing 204 may be composed of any suitable material, such as a metal, metal alloy, polymer or combinations thereof, which may be cast, stamped, molded and assembled to define the housing 204 for the user device 200.

The first recess 206 receives the entry key 104. The first recess 206 has a first chamber 210 and a second chamber 212 in communication with the first chamber 210. In this example, the first recess 206 is defined in the housing 204 such that a portion of the sidewall 204′ is removed to define the first chamber 210. The second chamber 212 is defined to extend into the housing 204, and in this example, is designed to extend into the housing 204 so as to be beneath the display 203. Thus, the second chamber 212 is obscured from a view of the user.

The second recess 208 is in communication with the first chamber 210, and receives a key release actuator 214. In one example, the key release actuator 214 is a push button latch. In this example, the key release actuator 214 includes a button 216 and a latch 218. The button 216 is movable within the second recess 208 relative to a sidewall 204″. The movement of the button 216 moves the latch 218 relative to the first chamber 210 to release the entry key 104 from the housing 204. In one example, the depression of the button 216 by the user overcomes a biasing force applied by a biasing member, such as a spring 219, and translates the latch 218 relative to the first recess 206, enabling the entry key 104 to be pulled from the housing 204 by the application of a force 220. It should be understood, however, that various techniques may be employed to removably retain the entry key 104 within the housing 204. For example, in other embodiments, the housing 204 may not include the second recess 208, and the entry key 104 may be press-fit into the first recess 206 such that the entry key 104 is released from the housing 204 upon the application of a predefined force to pull the entry key 104 from the housing 204.

The entry key 104 includes a blade 250 and a bow or graspable portion 252. The entry key 104 may be composed of a metal, metal alloy or polymer, and may be cast, stamped, machined, etc. In one example, the blade 250 is substantially rectangular, and includes an internal cutout 254. The internal cutout 254 defines features 254′ that mate with the lock cylinder 24 to enable the entry key 104 to be used to move the lock bolt 26 to unlock the respective door 20. Thus, the shape and configuration of the internal cutout 254 corresponds with an internal shape defined by the lock cylinder 24 to enable the use of the entry key 104 to actuate the lock 22 of the vehicle 10. The internal cutout 254 may be cut or machined into the blade 250 after the formation of the entry key 104 along with the cutting or machining of the lock cylinder 24 to ensure the internal cutout 254 mates with the lock cylinder 24. The blade 250 is received within the second chamber 212 of the first recess 206 when the entry key 104 is coupled to the housing 204. Generally, the second chamber 212 is sized such that the blade 250 is press-fit within the housing 204, and the actuation of the key release actuator 214 enables the blade 250 to be removed from the housing 204 by the user pulling on the graspable portion 252.

The graspable portion 252 extends from the blade 250, and in various embodiments, the graspable portion 252 extends outward from the blade 250 such that the entry key 104 is substantially L-shaped. In one example, the graspable portion 252 is received within the first chamber 210 of the first recess 206 and cooperates to define a portion of the sidewall 204′. In this example, the graspable portion 252 includes a sidewall portion 256 that enables the graspable portion 252 to form the portion of the sidewall 204′ and a latch hook 258. The sidewall portion 256 comprises a metal, metal alloy or polymer that matches and corresponds with the material used to form the sidewall 204′ of the housing 204 such that the sidewall portion 256 resembles a portion of the housing 204. The sidewall portion 256 may be formed with the formation of the entry key 104, or may be separately formed, via casting, machining, stamping, etc., and coupled to the blade 250 of the entry key 104 during a post-processing step, via ultrasonic welding, overmolding, adhesives, etc. This enables the entry key 104 to be contained within the housing 204 in an aesthetically pleasing manner. Generally, the sidewall portion 256 corresponds with the sidewall 204′ of the housing 204 such that the graspable portion 252 of the entry key 104 is substantially flush with the sidewall 204′ of the housing 204 when the entry key 104 is retained within the first recess 206.

The latch hook 258 cooperates with the latch 218 of the housing 204 to releasably couple the entry key 104 to the housing 204. In this example, the latch hook 258 extends from the sidewall portion 256 of the graspable portion 252, and has a substantially C-shape for engaging with the latch 218. Upon depression of the button 216, the latch 218 translates relative to the first chamber 210, thereby disengaging from the latch hook 258 and enabling the entry key 104 to be removed from the housing 204.

The authentication system 106 is disposed within the housing 204, and is generally disposed under the display 203 of the user device 200. In various embodiments, the authentication system 106 is the transponder 260, which emits the one or more identification signals that provide a code or other identifier of a user. The code or other identifier of a user, in this example, an authorized user of the vehicle 10, is pre-stored in a memory associated with the transponder 260. The one or more identification signals output by the transponder 260 are received by the receiver 52, and communicated by the receiver 52 to the processor 44. The processor 44 processes the one or more identification signals to determine whether the code or other identifier of the user matches with a pre-defined or stored code or other identifier of an authorized user of the vehicle 10, which in one example, is retrieved by the processor 44 from the media 46. In this example, the authentication system 106 emits or outputs the one or more identification signals in response to one or more signals received from the transponder coil 50. As discussed, the transponder coil 50 generates the one or more signals based on one or more control signals received from the processor 44. The processor 44 outputs the one or more controls signals based on receipt of the signal from the starter input device 48, which indicates that a user is requesting to start the propulsion system 30.

In various embodiments, the user device 200 includes an authentication system 106′. The authentication system 106′ is the communication system 202 associated with the user device 200. In this example, the processor 44 transmits one or more signals over the communication system 42 of the vehicle 10, which are received by the communication system 202 of the user device 200. The microprocessor 201 of the user device 200, based on receipt of the signals from the processor 44, outputs the one or more identification signals to the processor 44 of the vehicle 10 over the communication system 202 of the user device 200 to provide the code or other identifier of the authorized user of the vehicle 10. The user device 200 may include one or both of the authentication systems 106, 106′.

Referring now to FIG. 3, the backup entry and user authentication system 100 is shown in greater detail according to various embodiments. In this embodiment, the portable device 102 is a housing 300, which may be associated with and coupled to a user device 302, including, but not limited to a smart phone. It will be understood, however, that the user device 302 coupled to the housing 300 may comprise any portable user device, including, but not limited to: a mobile computer (e.g., a tablet computer, a laptop computer, or a netbook computer); a video game device; a digital media player; a piece of home entertainment equipment; a digital camera or video camera; a wearable computing device (e.g., smart watch, smart glasses, smart clothing); or the like. In various embodiments, the housing 300 includes an entry key 104′ and the authentication system 106. As the entry key 104′ is substantially similar to the entry key 104 discussed with regard to FIGS. 1 and 2, the same reference numerals will be used to denote substantially similar or the same features.

In one example, the housing 300 includes a base 304, a first sidewall 306 and a second sidewall 308. The housing 300 may be composed of a metal, metal alloy or polymeric material, and may be cast, stamped, molded, etc. In this example, the housing 300 is composed of a polymeric material. The housing 300 is sized and shaped to receive the user device 302, and in this example, the housing 300 is sized and shaped to receive a smart phone. The housing 300 may also serve to protect the user device 302 from damage, such as during drops or falls. The first sidewall 306 and the second sidewall 308 extend upwardly from opposite sides of the base 304. The first sidewall 306 and the second sidewall 308 are spaced apart to receive and retain the user device 302. In this example, the first sidewall 306 contacts a first side 302′ of the user device 302 and the second sidewall 308 contacts a second side 302″ of the user device 302 to retain the user device 302 within the housing 300. One or more of the first sidewall 306 and the second sidewall 308 may include cut-outs or other openings to enable one or more features on the side of the user device 302 to be accessible by the user. The housing 300 may also include one or more flanges 310 that extend between the first sidewall 306 and the second sidewall 308. The one or more flanges 310 extend upwardly from the base 304 and assist in retaining the user device 302 within the housing 300. Generally, the housing 300 is configured such that the user device 302 is press-fit into the housing 300 and retained by the first sidewall 306, the second sidewall 308 and the one or more flanges 310, but the user device 302 may be removed from the housing 300 upon the user bending one or more of the first sidewall 306 or the second sidewall 308 to release the user device 302. The removal of the user device 302 from the housing 300 provides access to the entry key 104′.

The base 304 spans bottom surface 302′″ of the user device 302. The base 304 defines a recess 312. The recess 312 receives the entry key 104′. The recess 312 is shaped to correspond with the entry key 104′, and is generally shaped such that the entry key 104′ is press-fit into the recess 312. By sizing the recess 312 to enable a press-fit with the entry key 104′, the entry key 104′ is retained during the movement of the housing 300 and a force has to be applied to remove the entry key 104′. In this example, the recess 312 includes a notch 314. The notch 314 is defined through the base 304 along the recess 312 to enable the user to apply the force to remove the entry key 104′. The notch 314 is shown defined along the recess 312 at an area that corresponds with the graspable portion 262 of the entry key 104′; however, the notch 314 may be defined at any location of the recess 312. Moreover, the recess 312 need not include the notch 314 depending upon the flexibility of the housing 300.

The entry key 104′ includes the blade 250 and a graspable portion 320. The entry key 104′ may be composed of a metal, metal alloy or polymer, and may be cast, stamped, machined, etc. The entry key 104′ is sized and shaped to be received within the recess 312. The blade 250 includes the internal cutout 254 that defines features 254′, which mate with the lock cylinder 24 to enable the entry key 104′ to be used to unlock the respective door 20. The graspable portion 320 extends from the blade 250, and in various embodiments, the graspable portion 320 extends outward from the blade 250 such that the entry key 104′ is substantially L-shaped. In one example, the graspable portion 320 is substantially planar, such that the entry key 104′ is substantially flush with a surface 304′ of the base 304.

In this example, the authentication system 106 including the transponder 260 is disposed within the housing 300, and is generally disposed within the base 304. Thus, in this example, the housing 300 may be molded over or around the transponder 260. Alternatively, the transponder 260 may be received within and coupled to another recess associated with the base 304 of the housing 300, and enclosed by a cover, sealing flap or other enclosure device.

It should be noted that the authentication system 106 need not be positioned within the housing 204 of the user device 200 or the housing 300. Rather, in various embodiments, an authentication system 106″ may be coupled to the entry key 104, 104′ as shown in FIGS. 2 and 3. The authentication system 106″ is the transponder 260″, which emits or outputs the one or more identification signals that provide a code or other identifier of a user. The code or other identifier of a user, in this example, an authorized user of the vehicle 10, is pre-stored in a memory associated with the transponder 260″. The one or more identification signals output by the transponder 260″ are received by the receiver 52, and communicated by the receiver 52 to the processor 44. The processor 44 processes the one or more identification signals to determine whether the code or other identifier of the user matches with the pre-defined or stored code or other identifier of an authorized user of the vehicle 10 which in one example, is retrieved by the processor 44 from the media 46. In this example, the authentication system 106″ emits or outputs the one or more identification signals in response to one or more signals received from the transponder coil 50. As discussed, the transponder coil 50 generates the one or more signals based on one or more control signals received from the processor 44. The processor 44 outputs the one or more controls signals based on receipt of the signal from the starter input device 48, which indicates that a user is requesting to start the propulsion system 30. As shown in FIG. 2, the transponder 260″ is coupled to the entry key 104, and in FIG. 3, the transponder 260″ is coupled to the entry key 104′.

Generally, with reference to FIGS. 1 and 2, in order to assemble the backup entry and user authentication system 100 in which the portable device 102 is the user device 200, in one example, the transponder 260 of the authentication system 106 may be positioned within the housing 204 of the user device 200. Generally, the transponder 260 is positioned within the housing 204 so as to be beneath the display 203 and obscured from the view of the user. With the first recess 206 and the second recess 208 defined in the housing 204, the latch 218 and the button 216 are coupled to the housing 204. The entry key 104 is formed with the internal cutout 254 defined to correspond and mate with the lock cylinder 24 of the vehicle 10, and the sidewall portion 256 may be coupled to the entry key 104. The entry key 104 may be inserted into the first recess 206 such that the blade 250 is received within the second chamber 212. Alternatively, the transponder 260″ may be coupled to the entry key 104, with the code or other identifier of a user pre-stored in the associated memory, prior to insertion of the entry key 104 into the housing 204.

In order to use the backup entry and user authentication system 100 in which the portable device 102 is the user device 200, the user may actuate or depress the button 216 to translate the latch 218. With the latch 218 moved, the user may apply the force 220 to remove the entry key 104 from the first recess 206 of the housing 204. With the entry key 104 removed, the entry key 104 may be inserted into the lock cylinder 24 of the lock 22, and used to move the lock bolt 26 from a locked position to an unlocked position to gain entry into the vehicle 10 via the respective door 20.

Once within the vehicle 10, upon the actuation of the starter input device 48, the starter input device 48 communicates a signal to the processor 44. Upon receipt of the signal from the starter input device 48, in one embodiment, the processor 44 outputs one or more control signals to the transponder coil 50. Based on the receipt of the one or more control signals, the transponder coil 50 generates and outputs the one or more signals for the transponder 260, 260″ of the authentication system 106. The one or more signals energize the transponder 260, 260″, which outputs one or more signals that provide the code or other identifier of the user. The receiver 52 receives the one or more signals from the transponder 260, 260″ and communicates these signals to the processor 44. The processor 44 receives and processes the signals and determines whether the user is an authorized user of the vehicle 10. If true, the processor 44 enables the startup of the propulsion system 30. Otherwise, the processor 44 does not enable the propulsion system 30 to start.

In various embodiments, upon receipt of the signal from the starter input device 48, the processor 44 outputs one or more signals to the communication system 202 of the user device 200 via the communication system 42. The microprocessor 201 of the user device 200 receives the one or more signals, and outputs, via the communication system 202 of the user device 200, one or more signals that provide the code or other identifier of the user. The processor 44, via the communication system 42, receives and processes the signals from the communication system 202 and determines whether the user is an authorized user of the vehicle 10. If true, the processor 44 enables the startup of the propulsion system 30. Otherwise, the processor 44 does not enable the propulsion system 30 to start.

Generally, with reference to FIGS. 1 and 3, in order to assemble the backup entry and user authentication system 100 in which the portable device 102 is the housing 300, in one example, the housing 300 may be formed about the transponder 260 of the authentication system 106 such that the transponder 260 is positioned within the housing 300. Generally, the transponder 260 is positioned within the housing 300 so as to be beneath the surface 304′ of the base 304 and obscured from the view of the user. With the recess 312 and the notch 314 defined in the housing 300, the entry key 104′ is formed. With the internal cutout 254 defined to correspond and mate with the lock cylinder 24 of the vehicle 10, the entry key 104′ may be inserted into the recess 312 such that the entry key 104′ is substantially flush or coplanar with the surface 304′ of the base 304. Alternatively, the transponder 260″ may be coupled to the entry key 104′, with the code or other identifier of a user pre-stored, prior to insertion of the entry key 104′ into recess 312. With the entry key 104′ coupled to the recess 312, the user device 302 may be coupled to the housing 300.

In order to use the backup entry and user authentication system 100 in which the portable device 102 is the housing 300, the user may remove the user device 302 from the housing 300 by applying a force to bend or flex one or more of the first sidewall 306 and the second sidewall 308. With the user device 302 removed, the user may insert a finger or other object into the notch 314 and apply a force to remove the entry key 104′ from the recess 312. With the entry key 104′ removed, the entry key 104′ may be inserted into the lock cylinder 24 of the lock 22, and used to move the lock bolt 26 from a locked position to an unlocked position to gain entry into the vehicle 10.

Once within the vehicle 10, upon the actuation of the starter input device 48, the starter input device 48 communicates a signal to the processor 44. Upon receipt of the signal from the starter input device 48, in one embodiment, the processor 44 outputs one or more control signals to the transponder coil 50. Based on the receipt of the one or more control signals, the transponder coil 50 generates and outputs the one or more signals for the transponder 260, 260″ of the authentication system 106. The one or more signals energize the transponder 260, 260″, which outputs one or more signals that provide the code or other identifier of the user. The receiver 52 receives the one or more signals from the transponder 260, 260″ and communicates these signals to the processor 44. The processor 44 receives and processes the signals and determines whether the user is an authorized user of the vehicle 10. If true, the processor 44 enables the startup of the propulsion system 30. Otherwise, the processor 44 does not enable the propulsion system 30 to start.

Thus, the backup entry and user authentication system 100 enables the user to gain entry into the vehicle 10 in instances where the user is unable to use the keyless entry system, due to a misplacement of the key fob or an issue with a battery of the key fob, for example. Moreover, by incorporating the entry key 104, 104′ in a recess associated with a smart phone or other user device 200, such as the housing 204 of the user device 200 or the housing 300, the user is likely to have the entry key 104, 104′ on their person when using the vehicle 10. In addition, by including the authentication system 106, 106′, 106″ with the portable device 102, such as the user device 200 or the housing 300, the processor 44 may enable a start-up of the vehicle 10 upon actuation of the starter input device 48 and the receipt of the code or other identifier from the authentication system 106, 106′, 106″ that matches an authorized user. Thus, in instances where the user has lost the key fob or the key fob battery is dead, the user may still operate the vehicle 10. Stated another way, the various teachings of the present disclosure allows a user to not have to carry a key fob to gain entry into the vehicle 10 and to start the propulsion system 30 of the vehicle 10. This enables a user to rely only the user device 200, such as a smart phone, to enter the vehicle 10 and to start the vehicle 10 without having to carry a key fob (i.e. the user may still get into the vehicle 10 and start the propulsion system 30 of the vehicle 10, even if the user device 200 battery is dead and the user does not have the key fob or the key fob battery is dead).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A backup entry and user authentication system for a vehicle, comprising:
a smart phone having a display, a housing that defines a first recess and a second recess, the first recess in communication with the second recess, the first recess defined within the housing under the display, and the housing has a sidewall;
an entry key having a blade adapted to mate with a lock of a door of the vehicle to gain entry into the vehicle and a graspable portion, the blade of the entry key removably retained within the first recess such that the blade of the entry key is contained within the housing of the smart phone and the graspable portion defines a portion of the sidewall of the housing; and
a transponder associated with the smart phone that is responsive to an input to output one or more signals that identifies a user to a processor of the vehicle, and the processor of the vehicle enables a startup of a propulsion system of the vehicle based on the identification.

2. The system of claim 1, wherein a key release actuator is received at least partially within the second recess.

3. The system of claim 2, wherein the key release actuator includes a button coupled to a latch, and a movement of the button relative to the second recess moves the latch relative to the first recess to release the entry key.

4. The system of claim 3, wherein the graspable portion of the entry key is substantially flush with the sidewall of the housing when the blade of the entry key is retained within the first recess.

5. The system of claim 1, wherein the transponder is disposed within the housing of the smart phone.

6. The system of claim 1, wherein the transponder is coupled to the entry key.

7. A backup entry and user authentication system for a vehicle, comprising:
a housing having a base that includes a first surface opposite a second surface, the first surface defines a recess and a notch adjacent to the recess, the notch in communication with the recess, the housing adapted to receive a portable user device, and the housing includes a first sidewall spaced apart from a second sidewall, the first sidewall and the second sidewall extend upwardly from the first surface of the base, the first sidewall and the second sidewall adapted to retain the portable device;
an entry key having a blade adapted to mate with a lock of a door of the vehicle to gain entry into the vehicle, the entry key removably retained within the recess such that the entry key is flush with the first surface, the entry key including a graspable portion, the graspable portion retained within the recess so as to be in communication with the notch; and
a transponder positioned within the base of the housing beneath the first surface that is responsive to an input to output one or more identifier signals that identifies a user to a processor of the vehicle and the processor of the vehicle enables a startup of a propulsion system of the vehicle based on the identification.

8.-11. (canceled)

12. A backup entry and user authentication system for a vehicle, comprising:
a smart phone having a display, a housing that defines a first recess through a portion of a sidewall of the housing and a second recess, the first recess in communication with the second recess, the first recess defined within the housing under the display, and the housing has a sidewall;
an entry key having a blade adapted to mate with a lock of a door of the vehicle to gain entry into the vehicle and a graspable portion, the blade of the entry key removably retained within the first recess such that the blade of the entry key is contained within the housing of the smart phone under the display, and the graspable portion includes a sidewall portion that corresponds with the sidewall of the housing such that the graspable portion of the entry key is flush with the sidewall of the housing and the graspable portion defines a portion of the sidewall of the housing; and
a transponder disposed within the housing that is responsive to an input to output one or more identifier signals that identifies a user to a processor of the vehicle and the processor of the vehicle enables a startup of a propulsion system of the vehicle based on the identification.

13. The system of claim 12, wherein a key release actuator is received at least partially within a second recess defined in the housing.

14. The system of claim 13, wherein the key release actuator includes a button coupled to a latch, and a movement of the button relative to the second recess moves the latch relative to the first recess to release the entry key.
